(19) United States
(12) Patent Application Publication
(10) Pub. No.: US 2018/0048642 A1
(43) Pub. Date: Feb. 15, 2018

(54) WIRELESS NETWORK APPARATUS, WIRELESS NETWORK SYSTEM, AND NON-TRANSITORY COMPUTER READABLE MEDIUM

(71) Applicant: FUJI XEROX CO., LTD., Tokyo (JP)

(72) Inventors: Masaki KUROKAWA, Kanagawa (JP); Takeshi ICHIMURA, Kanagawa (JP); Nobuyuki OBAYASHI, Kanagawa (JP); Kenji NOMURA, Kanagawa (JP); Kenji KOGURE, Kanagawa (JP)

(73) Assignee: FUJI XEROX CO., LTD., Tokyo (JP)

(21) Appl. No.: 15/606,138

(22) Filed: May 26, 2017

(30) Foreign Application Priority Data
Aug. 15, 2016 (JP) 2016-159076

(51) Int. Cl. H04L 29/06

(52) U.S. Cl. CPC H04L 63/0853; H04L 63/105; H04L 63/0892; H04W 12/06

(57) ABSTRACT

A wireless network apparatus includes a wireless communication unit, a receiving unit, an acquisition unit, and a setting unit. The wireless communication unit performs wireless communication with a mobile terminal apparatus. The receiving unit receives user identification information regarding a user corresponding to the mobile terminal apparatus in which network connection information assigned in advance to the user is set. The network connection information includes an identification name and authentication information that are used for network connection. The acquisition unit acquires network connection information set in association with the user identification information received by the receiving unit. The setting unit sets, in the wireless communication unit, the network connection information acquired by the acquisition unit.

### CROSS-REFERENCE TO RELATED APPLICATIONS

This application is based on and claims priority under 35 USC 119 from Japanese Patent Application No. 2016-159076 filed Aug. 15, 2016.

### BACKGROUND

### Technical Field

The present invention relates to a wireless network apparatus, a wireless network system, and a non-transitory computer readable medium.

### SUMMARY

According to an aspect of the invention, there is provided a wireless network apparatus including a wireless communication unit, a receiving unit, an acquisition unit, and a setting unit. The wireless communication unit performs wireless communication with a mobile terminal apparatus. The receiving unit receives user identification information regarding a user corresponding to the mobile terminal apparatus in which network connection information assigned in advance to the user is set. The network connection information includes an identification name and authentication information that are used for network connection. The acquisition unit acquires network connection information set in association with the user identification information received by the receiving unit. The setting unit sets, in the wireless communication unit, the network connection information acquired by the acquisition unit.

### BRIEF DESCRIPTION OF THE DRAWINGS

An exemplary embodiment of the present invention will be described in detail based on the following figures, wherein:

FIG. 1 is a diagram illustrating the overall configuration of a wireless network system according to the exemplary embodiment of the present invention and is also a block diagram of apparatuses in the wireless network system;

FIG. 2 is a diagram illustrating the hardware configuration of an image forming apparatus in the exemplary embodiment;

FIG. 3 is a table illustrating an example data structure of user information set and registered in advance in a user information memory in the exemplary embodiment;

FIG. 4 is a flowchart illustrating a wireless connection process in the exemplary embodiment; and

FIG. 5 is a table illustrating an example of setting network data for an access point supporting a multi service set identifier (SSID).

### DETAILED DESCRIPTION

Hereinafter, an exemplary embodiment of the present invention will be described on the basis of the drawings.

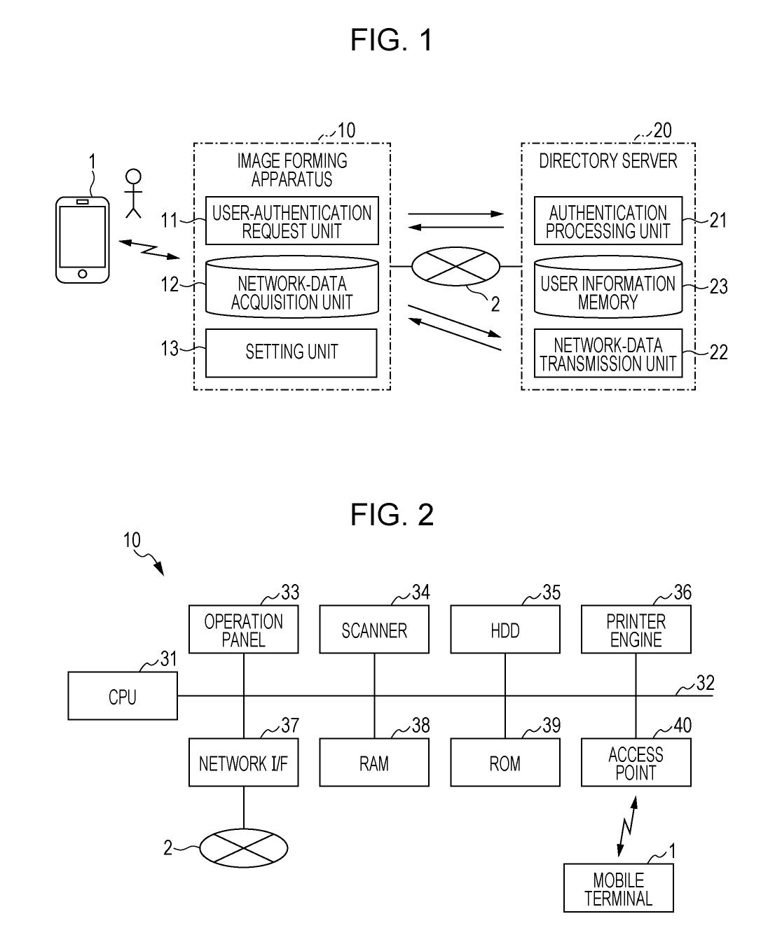

FIG. 1 is a diagram illustrating the overall configuration of a wireless network system according to the exemplary embodiment of the present invention and is also a block diagram of apparatuses in the wireless network system. FIG. 1 illustrates one of image forming apparatuses 10 that are each an example of a wireless network apparatus, a mobile terminal 1 carried by a user of the image forming apparatus 10, and a directory server 20. A company has multiple offices, and image forming apparatuses 10 are installed in the offices. Since each image forming apparatus 10 needs to have only a configuration that is characteristic to the exemplary embodiment described below, FIG. 1 illustrates only one image forming apparatus 10 for convenience. Although the exemplary embodiment is described under the assumption that each image forming apparatus 10 is installed in a corresponding one of the offices, multiple image forming apparatuses 10 may be installed in each office.

The directory server 20 is connected to each image forming apparatus 10 in the corresponding office via a network 2. The mobile terminal 1 is a mobile terminal apparatus carried by the user. The exemplary embodiment is described under the assumption that the mobile terminal apparatus is a smartphone. However, any other mobile terminal apparatus such as a tablet terminal is usable, as long as the mobile terminal apparatus is capable of wireless communication with the image forming apparatus 10 through Wi-Fi Direct.

FIG. 2 is a diagram illustrating the hardware configuration of the image forming apparatus 10 in the exemplary embodiment. The image forming apparatus 10 is a multifunction printer having various functions such as a printing function, a copying function, and a scanning function and has a computer incorporated therein. In FIG. 2, in accordance with a program stored in a read-only memory (ROM) 39, a central processing unit (CPU) 31 controls operations of various mechanisms such as a scanner 34 and a printer engine 36 that are included in the image forming apparatus 10. An address data bus 32 is connected to the mechanisms to be controlled by the CPU 31, and data communication is thereby performed. An operation panel 33 receives an instruction from the user and displays information. The scanner 34 reads a document set by the user and accumulates a reading result as electronic data in a hard disk drive (HDD) 35 or the like. The HDD 35 stores therein an electronic document or the like read with the scanner 34. The printer engine 36 prints an image on an output sheet in accordance with an instruction from a control program run by the CPU 31. A network interface (I/F) 37 connects to the network 2 and is used for data exchange and the like with the directory server 20 in the exemplary embodiment. A random-access memory (RAM) 38 is used as a work memory when the program is run and as a communication buffer when the electronic data is exchanged. The ROM 39 stores various programs for controlling the image forming apparatus 10, encrypting electronic data, and transmitting and receiving electronic data. When the various programs are run, components (described later) exert predetermined processing functions. An access point 40 is a wireless communication unit having an access point function and performs wireless communication with the mobile terminal 1 through Wi-Fi Direct.

The mobile terminal 1 has a computer incorporated therein and includes a CPU, a ROM, a RAM, a storage, a touch panel, a network interface, and other components. The directory server 20 is composed of a server computer and includes a CPU, a ROM, a RAM, a HDD, a network interface, and other components. The mobile terminal 1 and the directory server 20 may be implemented in an existing hardware configuration.

Referring back to FIG. 1, the image forming apparatus 10 in the exemplary embodiment includes a user-authentication request unit 11, a network-data acquisition unit 12, and a setting unit 13. Note that components that are not described in the exemplary embodiment are omitted in FIG. 1. The user-authentication request unit 11 functions as a receiving unit that receives user identification information (hereinafter, a “user ID”) of the user and a password and further as an authentication request unit that requests the directory server 20 to authenticate the user. The network-data acquisition unit 12 functions as an acquisition unit that acquires, from the directory server 20, network connection information set in association with a user ID received by the user-authentication request unit 11. The setting unit 13 functions as a setting unit that sets, in the access point 40, the network connection information acquired by the network-data acquisition unit 12.

The user-authentication request unit 11, the network-data acquisition unit 12, and the setting unit 13 of the image forming apparatus 10 are implemented through cooperative operations performed by the computer included in the image forming apparatus 10 and the program run by the CPU 31 included in the computer.

The directory server 20 in the exemplary embodiment includes an authentication processing unit 21, a network-data transmission unit 22, and a user information memory 23. The authentication processing unit 21 performs user authentication in response to a user authentication request from the image forming apparatus 10. The network-data transmission unit 22 transmits back network data in response to a network-data transmission request from the image forming apparatus 10.

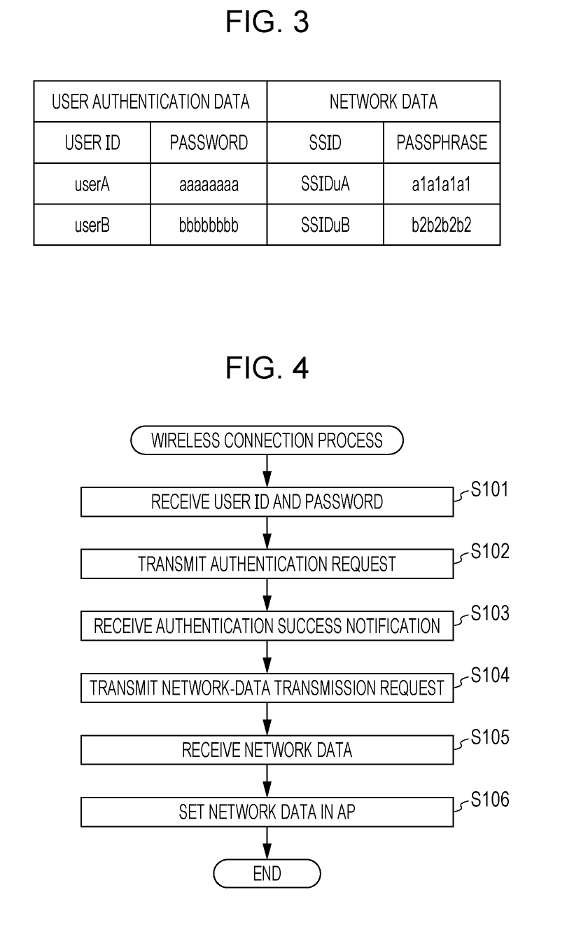

FIG. 3 is a table illustrating an example data structure of user information set and registered in advance in the user information memory 23 in the exemplary embodiment. The user information is stored in such a manner that user authentication data and network data that is information for network connection are set in association with each other. The user authentication data is referred to at the time of the user authentication and composed of a set of the user ID of a user and a password or a set of a user ID, a password, and identification information regarding an integrated circuit (IC) card held by the user. The network data is data that is set as access point connection information and is composed of a set of an SSID that is information identifying an access point and a passphrase that is authentication information for connecting to the network. As clear from this setting example, the network data is set on a per-user basis. The exemplary embodiment assumes that a piece of network data having content unique to a user is set in association with them but may be configured to allow a piece of network data to be set in association with multiple users.

The authentication processing unit 21 and the network-data transmission unit 22 of the directory server 20 are implemented through cooperative operations performed by the computer included in the directory server 20 and a program run by the CPU included in the computer. The user information memory 23 is implemented by using the HDD included in the directory server 20 or by using the RAM or an external memory through a network.

The programs used in the exemplary embodiment may be provided by using not only a communication medium but also in such a manner as to be stored in a computer readable recording medium such as a compact disc (CD)-ROM or a universal serial bus (USB) memory. The programs provided by using the communication medium or the recording medium are installed on the computers and sequentially run by each computer. Various processes are thereby implemented.

A process executed in the exemplary embodiment until the user wirelessly connects the mobile terminal 1 to one of the image forming apparatuses 10 will be described by using a flowchart illustrated in FIG. 4. Note that before the wireless connection process is started, no network data (a set of an SSID and a passphrase) may have been set in the access point 40 of the image forming apparatus 10, or a set of an SSID and a passphrase that is unique to the image forming apparatus 10 may have been set. This may be initialized when a previous user performs a logout operation or when a user ID is acquired.

To wirelessly connect the mobile terminal 1 to the image forming apparatus 10, the user undergoes user authentication through Wi-Fi Direct before the connection. Accordingly, the user brings their staff identity card close to the reader (not illustrated) of the image forming apparatus 10. After the reader reads the user ID recorded in the staff identity card, the image forming apparatus 10 displays a password input screen on the operation panel 33 and prompts the user to input a password. After the user inputs the password, the user-authentication request unit 11 receives the user ID and the password (step S101). The user-authentication request unit 11 transmits the received user ID and password to the directory server 20 and thereby requests user authentication (step S102).

Upon receiving the authentication request, the authentication processing unit 21 of the directory server 20 checks the user ID and the password that are designated in the authentication request against user authentication data in the user information memory 23 and thereby performs the user authentication. The authentication processing unit 21 transmits the authentication result back to the image forming apparatus 10 having transmitted the authentication request. Note that the description is continued under the assumption that the user has been successfully authenticated.

After the user-authentication request unit 11 receives the notification of the successful authentication from the directory server 20 (step S103), the network-data acquisition unit 12 transmits a network-data transmission request including the user ID to the directory server 20 (step S104).

Upon receiving the network-data transmission request, the network-data transmission unit 22 of the directory server 20 reads out, from the user information memory 23, network data associated with the user ID designated in the network-data transmission request and transmits the network data to the image forming apparatus 10 having transmitted the network-data transmission request.

After the network-data acquisition unit 12 receives the network data transmitted from the directory server 20 (step S105), the setting unit 13 sets the network data in the access point 40 (step S106).

Note that the network data assigned in advance to the user is set in advance in the mobile terminal 1 carried by the user. For example, if the user ID of the user having undergone the user authentication is “userA”, “SSIDuA” and “a1a1a1” are set in advance as the SSID and the passphrase of the access point 40, respectively. Accordingly, setting the network data assigned to the user having the user ID “userA” in the access point 40 causes the mobile terminal 1 of the user to be wirelessly connected to the image forming apparatus 10 through Wi-Fi Direct after the user is authenticated. For example, in a case where the mobile terminal 1 searches for a wireless network apparatus near the mobile terminal 1 and where multiple network apparatuses are found, the SSIDs of the found multiple network apparatuses are displayed on the display screen of the mobile terminal 1. In such a case, the user needs to select one of the SSIDs that corresponds to an image forming apparatus intended to be used and instruct the mobile terminal 1 to connect to a network. However, in the exemplary embodiment of the present invention, even though multiple SSIDs of nearby wireless network apparatuses are found, the mobile terminal 1 identifies the image forming apparatus 10 having the SSID “SSIDuA”, that is, the same as the SSID “SSIDuA” set in the mobile terminal 1, exchanges the passphrase that is apparatus authentication information with the identified image forming apparatus 10, and thereby establishes wireless connection. The series of steps for establishing communication between the mobile terminal 1 and the image forming apparatus 10 may be automatically executed or may be performed one by one by prompting the user to proceed to a next step. This enables a connection process to be started after identifying an SSID corresponding to the image forming apparatus 10 intended to be used by the user and also enables omission of a step in which each of the mobile terminal 1 and the image forming apparatus 10 issues an instruction for exchanging authentication information. The communication protocol used between the mobile terminal 1 and the image forming apparatus 10 is not limited to Wi-Fi Direct, and a communication method by which the mobile terminal 1 and the image forming apparatus 10 are directly connected to each other is applicable, such as a Wi-Fi ad-hoc mode or connection through Bluetooth (registered trademark).

If the user moves to a different office and intends to wirelessly connect the mobile terminal 1 to one of the image forming apparatuses 10 that is installed in the office, the user may be authenticated for the image forming apparatus 10 in the same manner as above. Note that network data that is set in the access point 40 of the image forming apparatus 10 in the different office is the network data that is set in the directory server 20 in association with the user as described above. In other words, even in the case where the image forming apparatus 10 in the different office is used, the same network data is set. Accordingly, it is satisfactory to set only one piece of network data managed by the directory server 20 for the mobile terminal 1 in the mobile terminal 1. In other words, as long as only one piece of network data managed by the directory server 20 for the mobile terminal 1 is set in the mobile terminal 1, the mobile terminal 1 is wirelessly connected to any one of the image forming apparatuses 10 in multiple offices. In addition, for an image forming apparatus 10 in an office that the user has visited for the first time, the directory server 20 performs the user authentication, the network data associated with the user is set in the image forming apparatus 10 in the office the user has visited for the first time, and the image forming apparatus 10 is connected to the mobile terminal 1 of the user.

In the exemplary embodiment, the same network data (the network data that is set in association with the user having the user ID “userA” in the example above) is set in any one of the multiple image forming apparatuses 10. However, this network data is not network data that is concurrent in settings of the respective multiple image forming apparatuses 10 but network data that is settable in the multiple image forming apparatuses 10 and that is assigned to a user as described above. For example, if the mobile terminal 1 of the user having the user ID “userA” is wirelessly connected to an image forming apparatus P, “SSIDuA” and “a1a1a1” are set as an SSID and a passphrase, respectively, in the image forming apparatus P. If a mobile terminal 1 of a user having a user ID “userB” is wirelessly connected to an image forming apparatus Q different from the image forming apparatus P, “SSIDuB” and “b2b2b2” are set as an SSID and a passphrase, respectively, in the image forming apparatus Q. As described above, the same network data is not set at the same time in the image forming apparatuses P and Q.

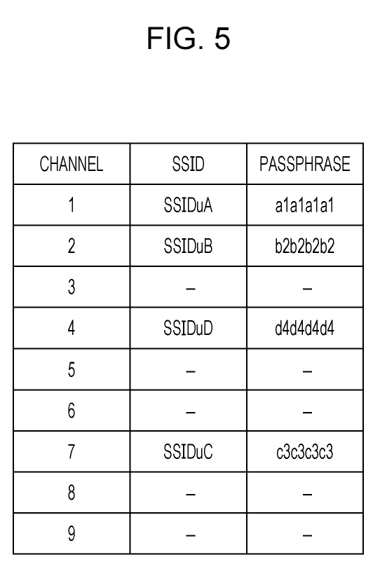

In the description above, only one user (one mobile terminal 1) may use one of the image forming apparatuses 10 through wireless connection. However, if an access point supporting the multi SSID enabling multiple SSIDs to be set in one access point is used, the image forming apparatus 10 may be wirelessly connected to multiple mobile terminals 1 simultaneously. FIG. 5 illustrates an example of setting network data for the access point supporting the multi SSID. In the example illustrated in FIG. 5, nine channels may be simultaneously connected to an access point. Note that “-” in FIG. 5 denotes that an SSID or a passphrase has not been set.

Note that the exemplary embodiment assumes that the directory server 20 is installed outside the multiple offices and that each image forming apparatus 10 performs data communication with the directory server 20 through the Internet. However, the directory server 20 may be installed in one of the offices. In addition, the user authentication process and the network data provision process are executed by using one directory server 20 but may be executed by using different servers, respectively.

In the exemplary embodiment, a password is input by a user from the viewpoint of security. However, to set network data, only inputting a user ID is needed. Alternatively, instead of inputting a user ID, an IC card such as the staff identity card held by the user may be brought close to one of the image forming apparatuses 10 to input user information. For example, in a configuration in which an IC card held by a user is brought close to a reader to request the directory server 20 to perform authentication, the user brings the IC card held by them close to the reader of the image forming apparatus 10. The user-authentication request unit 11 of the image forming apparatus 10 transmits, to the authentication processing unit 21 of the directory server 20, only IC card identification information read from the IC card. The authentication processing unit 21 checks the received IC card identification information against the user information stored in the user information memory 23. Since the user information memory 23 stores the user ID and IC card identification information in association with each other, the authentication processing unit 21 may determine that the user associated with the received IC card identification information is authenticated and transmits, to the user-authentication request unit 11 of the image forming apparatus 10, a reply indicating that the user who has brought the IC card close to the reader is authenticated.

In the description of the exemplary embodiment, the wireless network system including the image forming apparatuses 10 that is each the wireless network apparatus is taken as an example. However, aside from the image forming apparatuses 10, the exemplary embodiment is applicable to a separately provided access point, a router having an access point function, an information processing apparatus having the access point function or including a device having the access point function, and the like.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A wireless network apparatus comprising:
a wireless communication unit that performs wireless communication with a mobile terminal apparatus;
a receiving unit that receives user identification information regarding a user corresponding to the mobile terminal apparatus in which network connection information assigned in advance to the user is set, the network connection information including an identification name and authentication information that are used for network connection;
an acquisition unit that acquires network connection information set in association with the user identification information received by the receiving unit; and
a setting unit that sets, in the wireless communication unit, the network connection information acquired by the acquisition unit.

2. The wireless network apparatus according to claim 1, further comprising:
an authentication request unit that requests authentication of the user by using the user identification information received by the receiving unit,
wherein if the user is successfully authenticated, the acquisition unit acquires the network connection information.

3. The wireless network apparatus according to claim 1,
wherein a plurality of pieces of the network connection information are settable in the wireless communication unit.

4. A wireless network system comprising:
one or more wireless network apparatuses;
a memory that stores network connection information that is set in association with user identification information, the network connection information being assigned in advance to a user and including an identification name and authentication information that are used for network connection;
a server that, in response to a network-connection-information acquisition request designating user identification information from one of the wireless network apparatuses, refers to the memory to find network connection information set in association with the designated user identification information and that transmits the found network connection information back to the wireless network apparatus; and
a mobile terminal apparatus in which network connection information is assigned in advance to a user of the mobile terminal apparatus,
wherein each wireless network apparatus includes
a wireless communication unit that performs wireless communication with the mobile terminal apparatus,
a receiving unit that receives user identification information regarding the user corresponding to the mobile terminal apparatus,
an acquisition unit that acquires network connection information transmitted back from the server in response to a network-connection-information acquisition request designating the user identification information received by the receiving unit, and
a setting unit that sets, in the wireless communication unit, the network connection information acquired by the acquisition unit.

5. A non-transitory computer readable medium storing a program causing a computer included in a wireless network apparatus to execute a process, the wireless network apparatus including a wireless communication unit that performs wireless communication with a mobile terminal apparatus, the process comprising:
receiving user identification information regarding a user corresponding to the mobile terminal apparatus in which network connection information assigned in advance to the user is set, the network connection information including an identification name and authentication information that are used for network connection;
acquiring network connection information set in association with the received user identification information; and
setting the acquired network connection information in the wireless communication unit.
